(19) United States
(12) Patent Application Publication
(10) Pub. No.: US 2005/0027489 A1
(43) Pub. Date: Feb. 3, 2005

(54) Phase extraction between coupled atom interferometers using ellipse-specific fitting

(75) Inventors: Mark A. Kasevich, Palo Alto, CA (US); Gregory T. Foster, New York, NY (US); Jeffrey Fixler, Palo Alto, CA (US); Jeffrey M. McGuirk, Boulder, CA (US)

Correspondence Address: Paul. D. Greeley, Esq.;Ohlandt, Greeley, Ruggiero & Perle, L.L.P., 10th Floor, One Landmark Square, Stamford, CT, 06901-2682, US

(73) Assignee: Yale University

(21) Appl. No.: 10/640,878

(22) Filed: Aug. 14, 2003

Related U.S. Application Data
(60) Provisional application No. 60/403,544, filed on Aug. 14, 2002.

(51) Int. Cl. G01V 7/06; G01V 7/04

(52) U.S. Cl. 702/189; 73/382 G

(57) ABSTRACT

There is provided a method for phase extraction between coupled atom interferometers using ellipse-specific fitting. The method includes fitting an ellipse to data representing a first gravimeter measurement and a second gravimeter measurement, and determining a phase shift between the first gravimeter measurement and the second gravimeter measurement based on a spread of the data around the ellipse.

### CROSS-REFERENCE TO RELATED APPLICATIONS

The present application is claiming priority of U.S. Provisional Patent Application Ser. No. 60/403,544, filed on Aug. 14, 2002.

This invention was made with U.S. Government support under grant number K00113 awarded by the Office of Naval Research.

### BACKGROUND OF THE INVENTION

1. Field of the Invention

The present invention relates to phase extraction between coupled atom interferometers, and more specifically, an analysis technique involving ellipse-specific fitting of sinusoidally coupled data from two gravimeters in a gradiometer configuration. This technique permits rapid extraction of induced gradient phase shifts in the presence of common mode vibrational phase noise. Gravity gradients can be accurately measured in the presence of large vibrational accelerations.

2. Description of the Related Art

Gravimetry measures a local value of a gravitational acceleration field, as caused by the Earth and surrounding objects. Gravimeters determine acceleration induced on a test mass from a surrounding source mass, relative to an inertial platform. Local mapping of the gravitational field and a spatial gravitational gradient has important applications in geodesy, covert navigation, underground structure detection, and oil/mineral exploration.

A significant limitation of gravimetry is vibration of a reference platform, appearing as acceleration noise as a consequence of the Equivalence Principle. Common mode vibrational noise rejection has been demonstrated to a high level, but accurate extraction of small gravitational gradient signals was difficult if the vibrational induced phase noise was larger than π/2 rad.

### SUMMARY OF THE INVENTION

There is provided a method for phase extraction between coupled atom interferometers using ellipse-specific fitting. The method includes fitting an ellipse to data representing a first gravimeter measurement and a second gravimeter measurement, and determining a phase shift between the first gravimeter measurement and the second gravimeter measurement based on a spread of the data around the ellipse.

The first gravimeter measurement and the second gravimeter measurement are sinusoidal signals with a relative phase difference. Fitting the ellipse to the data includes finding algebraic coefficients that minimize a sum of squared algebraic distances to a conic for the data.

The first gravimeter measurement is provided by a first gravimeter and the second gravimeter measurement is provided by a second gravimeter. Each of the first and second gravimeters includes a laser for a phase reference.

The first gravimeter measurement and the second gravimeter measurement are taken from a sample mass, and the method further includes applying a magnetic pulse to the sample mass for biasing the phase shift.

### BRIEF DESCRIPTION OF THE DRAWINGS

FIG. 1 is a functional block diagram of a system configured for employment of the techniques described herein.

FIG. 2 is a graph of the two signals exhibiting a high level of vibrationally induced phase noise.

FIG. 3 is a graph of the signals from FIG. 2, showing the upper trace of FIG. 2 (y-axis) versus the lower trace of FIG. 2 (x-axis).

FIG. 4 is a graph of simulated scanned data without vibrational phase noise.

FIG. 5 is a graph showing a comparison of an extracted magnetic phase shift with a known applied shift.

### DESCRIPTION OF THE INVENTION

The following articles provide background on various aspects of gravimetry and several of the techniques described herein:
(1) M. J. Snadden, J. M. McGuirk, P. Bouyer, KG. Haritos and M. A. Kasevich, Phys. Rev. Lett. 81, 971 (1998).
(2) J. M. McGuirk, G. T. Foster, J. B. Fixler, M. J. Snadden, and M. A. Kasevich, Phys. Rev. A, 65 033608 (2002).
(3) A. Fitzgibbon, M. Pilu, and R. Fisher, IEEE Transactions On Pattern Analysis and Machine Intelligence, 21 476 (1999).
(4) M. Kasevich, D. S. Weiss, E. Riis, K Moller, S. Kasapi, S. Chu, Phys. Rev. Lett. 66, 2297 1991.
(5) Atom Interferometry, edited by P. Berman (Academic Press, New York, 1997).
(6) J. M. McGuirk, G. T. Foster, J. B. Fixler, and M. A. Kasevich, Opt. Lett. 26, 364 (2001).
(7) W. Gander, G. Golub, and R. Strebel, BIT 34, 558 (1994).
(8) J. D. Prestage, R. L. Tjoelker, and L Maleki, Phys. Rev. Lett. 74, 3511 (1995).
(9) D. S. Weiss, B. C. Young, and S. Chu, Phys. Rev. Lett. 70, 2706 (1995).

The technique described herein is inherently immune to common mode phase noise and allows extraction of accurate gravity gradient phase shifts without the necessity of active vibration isolation of a reference platform, where the gravitational field is measured as a phase shift on the wave function of an ensemble of atoms. Vibration induced noise of a gravimeter reference platform appears as a phase shift indistinguishable from a true gravity signal. A gradiometer rejects this noise by taking the difference of two simultaneous acceleration measurements sharing a common reference frame. An example of an accurate and sensitive gravity gradiometer based upon atom interferometric techniques is described in (1) M. J. Snadden, J. M. McGuirk, P. Bouyer, KG. Haritos and M. A. Kasevich, Phys. Rev. Lett. 81, 971 (1998), and (2) J. M. McGuirk, G. T. Foster, J. B. Fixler, M. J. Snadden, and M. A. Kasevich, Phys. Rev. A, 65 033608 (2002).

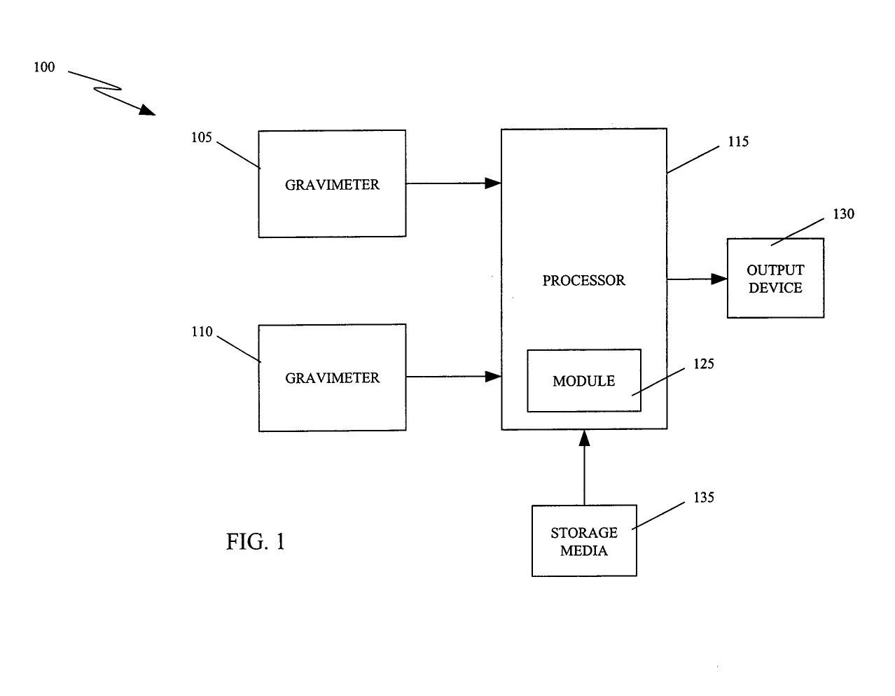

FIG. 1 is a functional block diagram of a system 100 configured for employment of the techniques described herein. System 100 includes two gravimeters 105 and 110, a processor 115 and an output device 130.

Gravimeters 105 and 110 are devices for measuring the local force of gravity on identical test masses, such as that caused by the Earth's gravity field and the gravity field of surrounding objects.

The measurements made by gravimeters 105 and 110 are performed simultaneously in a gradiometer configuration with gravimeters 105 and 110 spatially separated over a baseline. A gravitational acceleration is measured from each gravimeter. The difference of the two signals divided by the baseline separation is the gravity gradient. The orientation of the gravimeters and the measurement axis represents measurement of a component, or combinations thereof, of the gravity gradient tensor. Data readout from both gravimeters 105 and 110 are acquired simultaneously.

The signals from gravimeters 105 and 110 are sinusoids, with a relative phase shift measured in radians, which parametrically describe an ellipse. Common phase noise in the two sinusoids distributes data points around the ellipse, but does not change the ellipticity. Signals that are output from gravimeters 105 and 110 are input to processor 115.

Processor 115 receives the signals from gravimeters 105 and 110, organizes the signals into data sets, and fits an ellipse to the data sets to determine a phase shift. By fitting an ellipse to the data sets, a phase shift can be rapidly and accurately determined even in the presence of large common phase noise. Processor 115 includes a memory (not shown) that contains a module 125. Module 125, in turn, contains data and instructions for controlling processor 115 to perform the methods described herein. Module 125 may be configured as a plurality of subordinate modules or subroutines.

Processor 115 may be implemented on a general purpose microcomputer, such as one of the members of the Sun™ Microsystems family of computer systems, one of the members of the IBM™ Personal Computer family, or any conventional work-station or graphics computer device. Alternatively, it may be implemented as a special-purpose processor, that is, a processor specifically designed to process the signals from gravimeters 105 and 110.

Results from processor 115, i.e., data representing the phase shift, are output from processor 115 to an output device 130. Output device 130 may be a device that allows a user to view the output from processor 125, (e.g., a display, a printer, or a meter), or it may be a storage device or database from which another processor (not shown) may obtain the data for further processing.

While module 125 is indicated as already loaded into the memory of processor 115, it may be configured on a storage media 135 for subsequent loading into the memory. Storage media 135 can be any conventional storage media such as a magnetic tape, an optical storage media, a compact disk, or a floppy disk. Alternatively, storage media 135 can be a random access memory, or other type of electronic storage, located on a remote storage system (not shown).

The data from gravimeters 105 and 110 takes the form of two sinusoidal signals, with a relative phase difference, Δφ:
x=A′ sin(φ)+B′, y=C′ sin(φ+Δφ)+D′ (1)
In a limit of Δφ=π/2 and A′=C′, the data forms a circle in an x-y plane centered at (x,y)=(B′,D′). In an extreme case of Δφ=0 (or π), the data collapses to a line.

The general algebraic form of a conic is:
a·x=Ax²+Bxy+Cy²+Dx+Ey+F=0 (2)
where x=[x²,xy,y²,y,y,1] and a=[A,B,C,D,E,F]^{T}. The phase difference, Δφ, can be expressed in terms of the conic parameters:
Δφ=cos⁻¹(−B/2\sqrt{AC}) (3)
An ellipse-specific fitting routine developed for pattern recognition and vision simulation is employed to fit the ellipse parameter. For an example, see A. Fitzgibbon, M. Pilu, and R. Fisher, IEEE Transactions On Pattern Analysis and Machine Intelligence, 21 476 (1999). This technique finds the algebraic coefficients a that minimize the sum of the squared algebraic distances to the conic for the data points:
min∥Da∥² (4)
where D=[x₁ x₂ . . . xₙ]^{T} is an n×6 design matrix for n data points. To avoid a trivial solution a=0 and keep the system determined, the fit is constrained to be an ellipse through the discriminant: B²−4AC<0. The data may be scaled so that the constraint becomes an equality, B²−4AC=−1, allowing the minimization problem to be solved through the use of Lagrange multipliers. This reformulates the problem into determining the solutions of a matrix eigenvalue equation with a constraint. An eigenvector with the positive eigenvalue provides real parameters that satisfy the ellipse constraint. For an example, see A. Fitzgibbon, M. Pilu, and R. Fisher, IEEE Transactions On Pattern Analysis and Machine Intelligence, 21 476 (1999).

An experiment involving a gravity gradiometer is described in (1) M. J. Snadden, J. M. McGuirk, P. Bouyer, KG. Haritos and M. A. Kasevich, Phys. Rev. Lett. 81, 971 (1998), and (2) J. M. McGuirk, G. T. Foster, J. B. Fixler, M. J. Snadden, and M. A. Kasevich, Phys. Rev. A, 65 033608 (2002). The gradiometer includes two gravimeters separated by 1.4 meters that share a common vertical measurement axis. In each gravimeter, laser cooled Cs atoms are trapped in a magneto-optical trap (MOT) and then launched via light induced forces on a ballistic trajectory. During a 320 millisecond (ms) atomic fountain, a series of Doppler-sensitive two-photon Raman laser pulses drives transitions between the Cs 6S_{1/2} F=3 and F=4 hyperfine ground states. See M. Kasevich, D. S. Weiss, E. Riis, K Moller, S. Kasapi, S. Chu, Phys. Rev. Lett. 66, 2297 1991. The laser acts as a phase reference while the atoms accrue a gravitationally induced phase shift throughout the fountain. Following a π/2-π-π/2 interferometer sequence, the probability of finding an atom in the F=4 state is given by:

$${P}_{\vert 4 〉} = \frac{1}{2} [ 1 - cos ( {ϕ}_{0} + {Δϕ}_{g} ) ] \qquad ( 5 )$$

For background regarding Eq. 5, see Atom Interferometry, edited by P. Berman (Academic Press, New York, 1997). The induced gravitational phase shift is given by Δφ_{g}=2k_{eff}gT² where k_{eff} is the effective laser wavevector, g is the gravity over the interferometer path, and T is the time between interferometer pulses. φ₀=φ₁−2φ₂+φ₃ contains the laser phase at each pulse. A π pulse denotes a pulse envelope area such that the Cs atoms undergo complete population reversal from one hyperfine state to the other. A π/2 pulse creates a superposition of states. The F=4 population is detected using balanced detection with modulation transfer spectroscopy. See J. M. McGuirk, G. T. Foster, J. B. Fixler, and M. A. Kasevich, Opt. Lett. 26, 364 (2001). The phase of the first interferometer π/2 pulse, φ₁, is acousto-optically scanned to map out the sinusoidal interference fringe given by Eq. 5. In the absence of vibrational noise in φ₀, the laser phase is precisely known, and the phase of the interference fringe yields the gravitational acceleration.

The difference phase suppresses common mode vibrations at a level of better than 140 dB for Δφ=0. In this case, both sinusoids are in phase, and the common-mode performance of the system can be characterized through direct subtraction of appropriately normalized signals using Gaussian elimination. In the absence of vibrations, the relative phase can be directly determined by fitting sinusoids to the data sets. This technique is also effective at suppressing small common phase noise. In a noisier environment, an active servo is required to keep the system noise in a regime where sinusoids can be fit to the data sets.

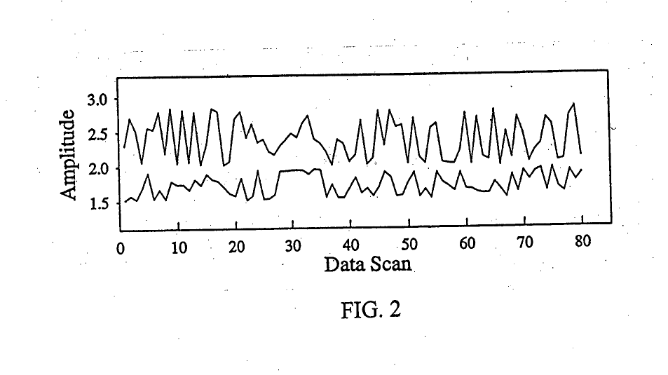

FIG. 2 is a graph of the two signals exhibiting a high level of vibrationally induced phase noise. Typical signals from two gravimeters are plotted individually for a T=150 ms Doppler sensitive interferometer where common phase noise dominates (uncorrelated amplitude noise is estimated at the 100:1 level of the detected atom signal). For clarity, the upper data is offset by one amplitude. The large phase noise prevents a sinusoidal least-squares fit from producing accurate results.

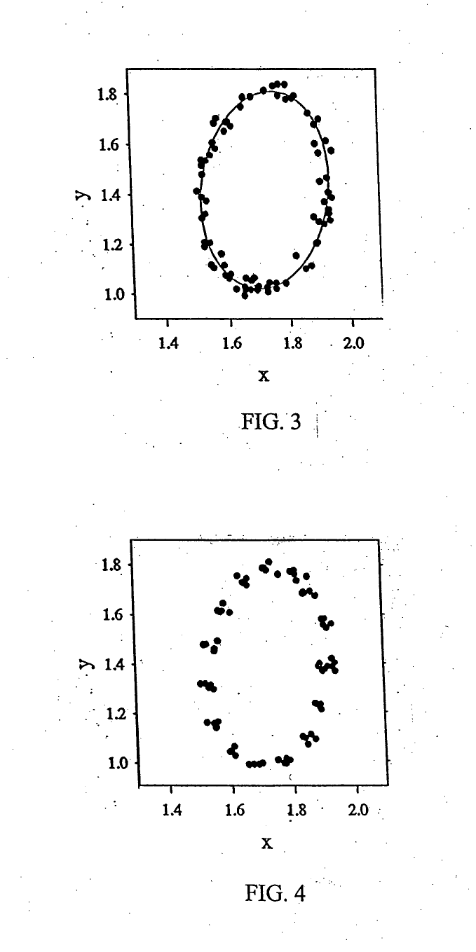

FIG. 3 is a graph of the signals from FIG. 2, showing the upper trace of FIG. 2 (y-axis) versus the lower trace of FIG. 2 (x-axis). FIG. 3 reveals the underlying elliptic constraint of the two data sets. The solid line is an ellipse fit to the data. The spread of the data around the ellipse is due to the presence of the large amount of phase noise.

FIG. 4 is a graph of simulated scanned gravity gradient relative phase shift data without vibrational induced phase noise. It includes an amount of non-vibrational noise at the same level as typical gradiometer data. FIG. 4 shows that if no phase noise was present, the data would be bunched closer to the scan phases about the ellipse.

To validate the accuracy of phase extraction through ellipse fitting, there is applied a phase that can be independently measured. A magnetic bias pulse is applied for 66.7 ms during the fist half of the fountain in the lower chamber via Helmholtz coils. The atoms in the fountain are state selected to be m_{f}=0, so they are insensitive to the first order Zeeman shift, but do experience a second order Zeeman shift. This phase shift can be measured independently with a π/2-π/2 microwave clock sequence during the fountain instead of the Doppler sensitive interferometer. This exhibits the same sensitivity to the magnetic bias phase shift but is insensitive to accelerations. A sinusoid is least-squares fit to the microwave fringes, and the phase shift is calibrated for a given applied coil current with the microwave clock. The ellipse fitting algorithm is used to extract the magnetic bias shift applied during Doppler sensitive interferometer sequences.

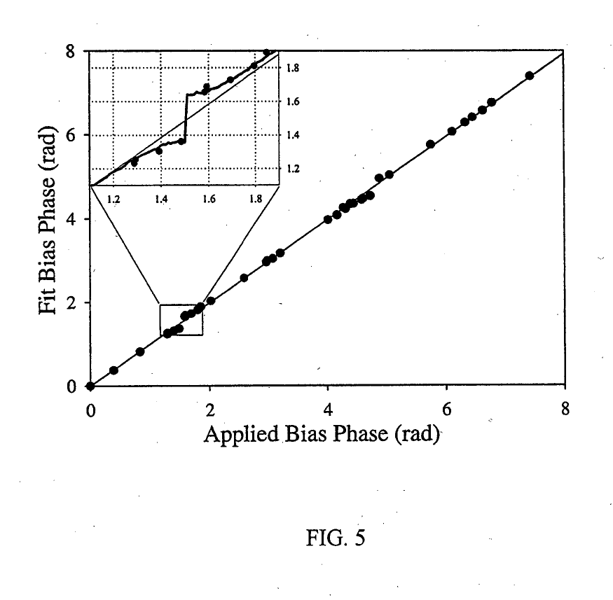

FIG. 5 is a graph showing a comparison of the extracted magnetic phase shift with the known applied shift. The main plot of FIG. 5 shows the phase extracted using ellipse-fitting of Doppler sensitive data (high phase noise) with a series of increasing applied magnetic bias pulse phase shifts. The inset figure of FIG. 5 expands the view of the deviation near π/2 and shows the deviation from linearity of the ellipse-fit phase shift around the applied magnetic shift of π/2 rad. The bold curve in the inset shows this behavior exhibited in simulations with amplitude noise of a percent.

Over more than 2π rad shift, there is a close correspondence to at least a part in 100, limited by the statistical uncertainty of the measurements. The ellipse and least-squares fitting produces statistically consistent results for the low noise microwave clock fringes. A small deviation is evident at the applied phases of π/2 and 3π/2.

FIG. 5 plots a measured bias shift that is determined by subtracting out the Earth's ≈π/2 rad gravity gradient phase shift measured with the Doppler sensitive interferometer from Δφ. At an applied bias of π/2 rad, Δφ≈0, and the data from the two chambers are in phase and nearly describe a line. The ellipse fitting method cannot accurately fit the phase near Δφ=0 (mod π) when amplitude noise is present. Accordingly, rather than operate near these phases, the magnetic bias pulse can be applied to shift away from these positions if necessary.

The ellipse analysis method is immune to the presence of common mode phase noise. In an exemplary embodiment, in addition to measurement of the Earth's gravitational gradient and magnetic phase shifts, the ellipse technique is used to measure gravitational phase shifts from a 600 kg Pb test mass that produces a signal of ≈150 mrad when moved near to the lower gravimeter. The accuracy of the ellipse fitting technique can be calibrated for detecting small gravitational phase shifts by applying a known magnetic bias pulse phase shift to null the signal from the test mass. Then, measure the phase shift produced by the test mass without the nulling bias field, and compare the directly measured phase shift with the inferred shift from the magnetic bias used to null the gravitational signal. The phase shifts agree with the statistical uncertainty of the measurements.

The ellipse fitting routine has been tested with simulated data for a range of amplitude and phase noise levels, including the noise environment of the gravity gradiometer. The results indicated no dependence on common mode phase noise. Simulations show that the phase uncertainty is determined by the level of amplitude noise. The standard deviation of the extracted phase is proportional to the level of amplitude noise present up to noise at an RMS level of 20 percent of the signal amplitude. Uncorrelated phase noise significantly affects the extraction of an accurate phase difference by spreading the data points within the limits of the box determined by the ellipse amplitudes. At a noise level of 0.05 rad RMS, the accuracy of the fit begins to deviate at a level larger than the mean uncertainty. This deviation is expected since the ellipse method is contingent upon data that share a definite phase relation. Uncorrelated phase noise in the gradiometer described herein is fat below this level.

Ellipse fitting by minimizing the squared algebraic distance to each point is more sensitive to outlying points of the ellipse compared to outlying points inside the ellipse. The sensitivity to points outside the ellipse permits easy rejection of these points. For noisy data lying inside the ellipse, a rejection cut can be made based on the ellipse parameters. By requiring minimization of the sum of the squares of the distances to the ellipse, i.e., the geometric distance dᵢ²=(∥z−xᵢ∥)² from points (xᵢ) to the ellipse (z), this sensitivity may be reduced. The fast algebraic fit is then useful for providing the initial estimates to be used in an iterative, geometric fit. For typical interferometer data, tests indicate the phase extracted by algebraic fits (Eq. 2) versus various iterative geometric fits (see W. Gander, G. Golub, and R. Strebel, BIT 34, 558 (1994)) with initial parameters determined from an ellipse specific fit agreed to within the statistical uncertainty of the data. The ellipse fit can also be biased away from the appropriate phase value if the data does not cover the entire ellipse. This can be avoided by fitting a larger number of data points or by filtering out data sets that do not meet a distribution requirement. Finally, the geometric criteria provide an effective means for rejecting outlying data points.

Thus, the method described herein for analyzing data from a gravity gradiometer exhibits immunity to common mode phase noise. This allows fast, accurate extraction of phase shifts without additional vibration isolation. The technique may be applicable to a variety of experiments outside of gradiometry, for example, a system with quadrature outputs that share common phase noise, such as in an optical interferometer or in homodyne detection. Another possibility is in precision measurements to search for changes in the fine structure constant a via interspecies clock comparisons (see J. D. Prestage, R. L. Tjoelker, and L Maleki, Phys. Rev. Lett. 74, 3511 (1995)). It might also be useful in other atom interferometry experiments, such as photon recoil measurements for measurement of h/m (see D. S. Weiss, B. C. Young, and S. Chu, Phys. Rev. Lett. 70, 2706 (1995)).

The techniques described herein are suitable for commercial gravimeter and gradiometer applications where a noisy environment or platform exists. Such applications include use onboard a moving platform or stationary in a vibrationally noisy environment. These situations would be encountered for a gravity gradiometer for use in covert navigation, exploration of oil/mineral deposits via land or air vehicles, and geodesy.

It should be understood that various alternatives and modifications of the present invention could be devised by those skilled in the art. Nevertheless, the present invention is intended to embrace all such alternatives, modifications and variances that fall within the scope of the appended claims.

1. A method, comprising:
fitting an ellipse to data representing a first gravimeter measurement and a second gravimeter measurement; and
determining a phase shift between said first gravimeter measurement and said second gravimeter measurement based on a spread of said data around said ellipse.

2. The method of claim 1, wherein said first gravimeter measurement and said second gravimeter measurement are sinusoidal signals with a relative phase difference.

3. The method of claim 1, wherein said fitting comprises finding algebraic coefficients that minimize a sum of squared algebraic distances to a conic for said data.

4. The method of claim 1, wherein said first gravimeter measurement is provided by a first gravimeter and said second gravimeter measurement is provided by a second gravimeter.

5. The method of claim 4, wherein each of said first and second gravimeters includes a laser for a phase reference.

6. The method of claim 1, wherein said first gravimeter measurement and said second gravimeter measurement are taken from a sample mass, and wherein said method further comprises applying a magnetic pulse to said sample mass for biasing said phase shift.

7. The method of claim 1, wherein said method is employed to facilitate a technique selected from the group consisting of optical interferometry, homodyne detection and a photon recoil measurement.

8. A processor, comprising a module that:
fits an ellipse to data representing a first gravimeter measurement and a second gravimeter measurement; and
determines a phase shift between said first gravimeter measurement and said second gravimeter measurement based on a spread of said data around said ellipse.

9. The processor of claim 8, wherein said first gravimeter measurement and said second gravimeter measurement are sinusoidal signals with a relative phase difference.

10. The processor of claim 8, wherein said fit finds algebraic coefficients that minimize a sum of squared algebraic distances to a conic for said data.

11. The processor of claim 8, wherein said first gravimeter measurement is provided by a first gravimeter and said second gravimeter measurement is provided by a second gravimeter.

12. The processor of claim 11, wherein each of said first and second gravimeters includes a laser for a phase reference.

13. The processor of claim 8, wherein said first gravimeter measurement and said second gravimeter measurement are taken from a sample mass, and wherein said module applies a magnetic pulse to said sample mass for biasing said phase shift.

14. The processor of claim 8, wherein said processor facilitates a technique selected from the group consisting of optical interferometry, homodyne detection and a photon recoil measurement.

15. A storage media comprising instructions for controlling a processor that:
fits an ellipse to data representing a first gravimeter measurement and a second gravimeter measurement; and
determines a phase shift between said first gravimeter measurement and said second gravimeter measurement based on a spread of said data around said ellipse.

16. The storage media of claim 15, wherein said first gravimeter measurement and said second gravimeter measurement are sinusoidal signals with a relative phase difference.

17. The storage media of claim 15, wherein said fit finds algebraic coefficients that minimize a sum of squared algebraic distances to a conic for said data.

18. The storage media of claim 15, wherein said first gravimeter measurement is provided by a first gravimeter and said second gravimeter measurement is provided by a second gravimeter.

19. The storage media of claim 18, wherein each of said first and second gravimeters includes a laser for a phase reference.

20. The storage media of claim 15, wherein said first gravimeter measurement and said second gravimeter measurement are taken from a sample mass, and wherein said instruction control said processor to apply a magnetic pulse to said sample mass for biasing said phase shift.

21. The storage media of claim 15, wherein said processor facilitates a technique selected from the group consisting of optical interferometry, homodyne detection, and a photon recoil measurement.
